(19) United States
(12) Patent Application Publication
(10) Pub. No.: US 2012/0272180 A1
(43) Pub. Date: Oct. 25, 2012

(54) METHOD AND APPARATUS FOR PROVIDING CONTENT FLIPPING BASED ON A SCROLLING OPERATION

(75) Inventors: Jori Larres, Helsinki (FI); Mikko A. Nurmi, Tampere (FI)

(73) Assignee: Nokia Corporation

(21) Appl. No.: 13/090,724

(22) Filed: Apr. 20, 2011

(51) Int. Cl. G06F 3/048

(52) U.S. Cl. 715/784

(57) ABSTRACT

A method for providing content flipping based on a scroll operation may include causing display of a first side of a content tile on a display view of an electronic device where the content tile includes at least the first side including first content and a second side including second content, enabling performance of a scrolling operation with respect to contents of the display view, and causing the content tile to flip from displaying the first side to displaying the second side based on the scrolling operation. An apparatus and computer program product corresponding to the method are also provided.

### TECHNOLOGICAL FIELD

Embodiments of the present invention relate generally to user interface technology and, more particularly, relate to a method and apparatus for providing content flipping based on a scrolling operation.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer relates to the delivery of services to a user of a mobile terminal. The services may be in the form of a particular media or communication application desired by the user, such as a music player, a game player, an electronic book, short messages, email, content sharing, web browsing, etc. The services may also be in the form of interactive applications in which the user may respond to a network device in order to perform a task or achieve a goal. The services may be provided from a network server or other network device, or even from the mobile terminal such as, for example, a mobile telephone, a mobile television, a mobile gaming system, etc.

In many situations, it may be desirable for the user to interface with a device such as a mobile terminal for the provision of an application or service. A user's experience during certain applications such as, for example, web browsing may be enhanced by making the experience intuitive and making it easy to access information and functionalities of interest to the user. Thus, it may be desirable to continue to provide improvements in relation to the manner by which users are enabled to access information and functionalities.

### BRIEF SUMMARY OF SOME EXAMPLES

A method, apparatus and computer program product are therefore provided to enable content flipping based on a scrolling operation. In this regard, in some example embodiments, a mechanism is provided for providing content tiles that are at least two sided. Each content tile may include content on a first side and may include, on a second side, either information about the content that is on the first side and/or additional content that is related or unrelated to the content that is on the first side. Moreover, in some examples, the content may be flipped between the sides based on a scrolling operation (e.g., rather than flipping based on selection of the content tiles). As such, embodiments of the present invention may provide an intuitive and interesting way by which users may access content and/or information.

In an example embodiment, a method of providing content flipping based on a scrolling operation is provided. The method may include causing display of a first side of a content tile on a display view of an electronic device where the content tile includes at least the first side including first content and a second side including second content, enabling performance of a scrolling operation with respect to contents of the display view, and causing the content tile to flip from displaying the first side to displaying the second side based on the scrolling operation.

In another example embodiment, a computer program product for providing content flipping based on a scrolling operation is provided. The computer program product includes at least one computer-readable storage medium having computer-executable program code instructions stored therein. The computer-executable program code instructions may include program code instructions for causing display of a first side of a content tile on a display view of an electronic device where the content tile includes at least the first side including first content and a second side including second content, enabling performance of a scrolling operation with respect to contents of the display view, and causing the content tile to flip from displaying the first side to displaying the second side based on the scrolling operation.

In another example embodiment, an apparatus for providing content flipping based on a scrolling operation is provided. The apparatus may include at least one processor and at least one memory including computer program code. The at least one memory and the computer program code may be configured, with the at least one processor, to cause the apparatus to perform at least causing display of a first side of a content tile on a display view of an electronic device where the content tile includes at least the first side including first content and a second side including second content, enabling performance of a scrolling operation with respect to contents of the display view, and causing the content tile to flip from displaying the first side to displaying the second side based on the scrolling operation.

In yet another example embodiment, an apparatus for providing content flipping based on a scrolling operation is provided. The apparatus may include means for causing display of a first side of a content tile on a display view of an electronic device where the content tile includes at least the first side including first content and a second side including second content, means for enabling performance of a scrolling operation with respect to contents of the display view, and means for causing the content tile to flip from displaying the first side to displaying the second side based on the scrolling operation.

Embodiments of the invention may provide a method, apparatus and computer program product for employment, for example, in mobile or fixed environments. As a result, for example, computing device users may enjoy an improved capability for accessing content and/or information.

### BRIEF DESCRIPTION OF THE SEVERAL VIEWS OF THE DRAWING(S)

Having thus described some embodiments of the invention in general terms, reference will now be made to the accompanying drawings, which are not necessarily drawn to scale, and wherein:

FIG. 1 illustrates a block diagram of a mobile terminal that may benefit from an example embodiment of the present invention;

FIG. 2 is a schematic block diagram of a wireless communications system according to an example embodiment of the present invention;

FIG. 3 illustrates an apparatus for enabling the provision of content flipping based on a scrolling operation according to an example embodiment of the present invention;

FIG. 4, which includes FIGS. 4A, 4B, 4C and 4D illustrates an example of content items displayed in a gallery format on a display view generated by an electronic device according to an example embodiment of the present invention;

FIG. 5 illustrates an example embodiment presented in a list format according to an example embodiment;

FIG. 6 illustrates the use of content tiles in connection with a map service or application according to an example embodiment; and

FIG. 7 is a flowchart according to an example method for providing content flipping based on a scrolling operation according to an example embodiment of the present invention.

### DETAILED DESCRIPTION OF SOME EMBODIMENTS

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

Electronic devices, both mobile and fixed, continue to evolve in relation to their ability to generate, modify, share, obtain and experience content. As the amounts and types of content that are consumable at various electronic devices continues to expand, it becomes harder and harder for users to manage the content. Furthermore, it can become difficult to associate content with information descriptive of the content or with other content that is related to the content. Device users have grown somewhat accustomed to the idea of clicking on content items in order to examine information about them or to engage some functionality that may be available in association with the content items. However, in some environments, only certain content items may have corresponding functionalities or information associated therewith. Thus, users may find themselves wasting their time clicking on content items, or otherwise searching for information or functionalities associated with certain content items that may be buried within a grouping of other content items that do not have such associated information and/or functionalities.

To save users time and effort, and also to improve the user's experience in relation to interacting with content of certain types, some example embodiments may provide an interesting and useful way by which users may access content or information associated with certain content items (or content tiles). In this regard, for example, some embodiments may enable the provision of content tiles that are at least two sided such that each of the two sided content tiles may include content on a first side and may include, on a second side, either information about the content that is on the first side and/or additional content that may be related or unrelated to the content that is on the first side. Some example embodiments may also provide that the content tiles may be flipped between the sides based on a scrolling operation (e.g., rather than flipping based on selection of the content tiles). In other words, for example, when a scrolling operation moves a content tile to a trigger location on a display screen, a flipping action may be initiated such that the content tile flips from one side (e.g., the first side) to another side (e.g., the second side) in order to reveal information about the content on the first side and/or a content item associated with or unrelated to the content on the first side. In some embodiments, scrolling may be linked directly to the angle of flipping a content tile such that, for example, when a user moves a scrollable view up to location X, a flipping tile flips to angle Y. However, if the content tile is flipped by scrolling to a different location X2, then the flipping may be viewed from a corresponding different angle Y2.

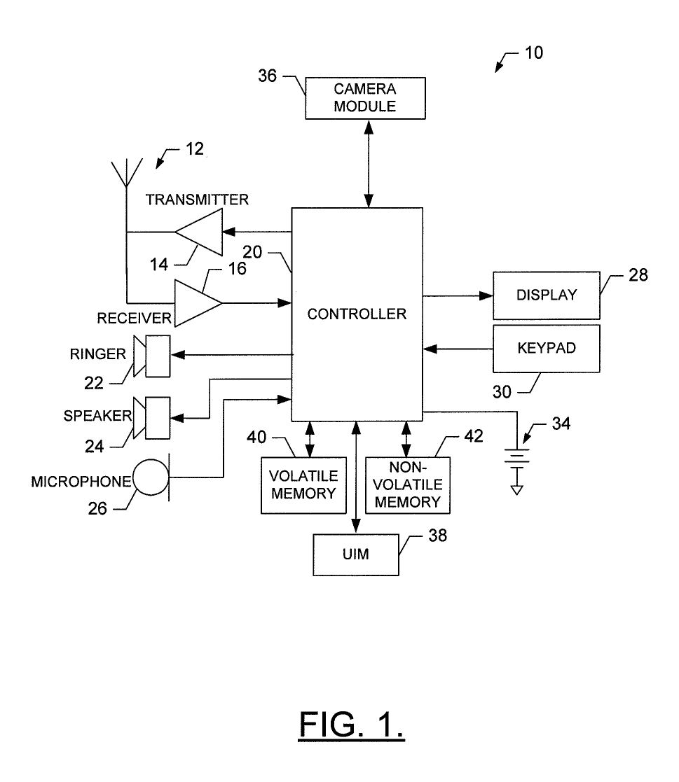

FIG. 1, one example embodiment of the invention, illustrates a block diagram of a mobile terminal 10 that may benefit from embodiments of the present invention. It should be understood, however, that a mobile terminal as illustrated and hereinafter described is merely illustrative of one type of device that may benefit from embodiments of the present invention and, therefore, should not be taken to limit the scope of embodiments of the present invention. While several embodiments of the mobile terminal 10 may be illustrated and hereinafter described for purposes of example, other types of mobile terminals, such as portable digital assistants (PDAs), pagers, mobile televisions, wearable devices, tablets, touch surfaces (table, wall), gaming devices, all types of computers (e.g., laptops or mobile computers), cameras, audio/video players, radio, global positioning system (GPS) devices, or any combination of the aforementioned, and other types of communications systems, may readily employ embodiments of the present invention. Furthermore, fixed electronic devices (e.g., personal computers (PCs), network access terminals, and/or the like) may also employ example embodiments in some cases.

The mobile terminal 10 may include an antenna 12 (or multiple antennas) in operable communication with a transmitter 14 and a receiver 16. The mobile terminal 10 may further include an apparatus, such as a controller 20 or other processor, that provides signals to and receives signals from the transmitter 14 and receiver 16, respectively. The signals may include signaling information in accordance with the air interface standard of the applicable cellular system, and/or may also include data corresponding to user speech, received data and/or user generated data. In this regard, the mobile terminal 10 may be capable of operating with one or more air interface standards, communication protocols, modulation types, and access types. By way of illustration, the mobile terminal 10 may be capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as E-UTRAN (evolved-universal terrestrial radio access network), with fourth-generation (4G) wireless communication protocols or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

It is understood that the apparatus, such as the controller 20, may include circuitry implementing, among others, audio and logic functions of the mobile terminal 10. For example, the controller 20 may comprise a digital signal processor device, a microprocessor device, and various analog to digital converters, digital to analog converters, and/or other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 may additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as an earphone or speaker 24, a ringer 22, a microphone 26, a display 28, and a user input interface, which may be coupled to the controller 20. The user input interface, which allows the mobile terminal 10 to receive data, may include any of a number of devices allowing the mobile terminal 10 to receive data, such as a keypad 30, a touch display (not shown specifically, although the display 28 may, in some cases, be an example), a microphone or other input device. In embodiments including the keypad 30, the keypad 30 may include numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are used to operate the mobile terminal 10, as well as optionally providing mechanical vibration as a detectable output.

In some embodiments, the mobile terminal 10 includes a media capturing element, such as a camera, video and/or audio module, in communication with the controller 20. The media capturing element may be any means for capturing an image, video and/or audio for storage, display or transmission. For example, in an example embodiment in which the media capturing element is a camera module 36, the camera module 36 may include a digital camera capable of forming a digital image file from a captured image. As such, the camera module 36 includes all hardware, such as a lens or other optical component(s), and software necessary for creating a digital image file from a captured image. Alternatively, the camera module 36 may include only the hardware needed to view an image, while a memory device of the mobile terminal 10 stores instructions for execution by the controller 20 in the form of software necessary to create a digital image file from a captured image. In an example embodiment, the camera module 36 may further include a processing element such as a co-processor which assists the controller 20 in processing image data and an encoder and/or decoder for compressing and/or decompressing image data. The encoder and/or decoder may encode and/or decode according to a JPEG standard format or another like format. In some cases, the camera module 36 may provide live image data to the display 28. Moreover, in an example embodiment, the display 28 may be located on one side of the mobile terminal 10 and the camera module 36 may include a lens positioned on the opposite side of the mobile terminal 10 with respect to the display 28 to enable the camera module 36 to capture images on one side of the mobile terminal 10 and present a view of such images to the user positioned on the other side of the mobile terminal 10.

The mobile terminal 10 may further include a user identity module (UIM) 38, which may generically be referred to as a smart card. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), or any other smart card. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The non-volatile memory 42 may additionally or alternatively comprise an electrically erasable programmable read only memory (EEPROM), flash memory or the like. The memories may store any of a number of pieces of information, and data, used by the mobile terminal 10 to implement the functions of the mobile terminal 10.

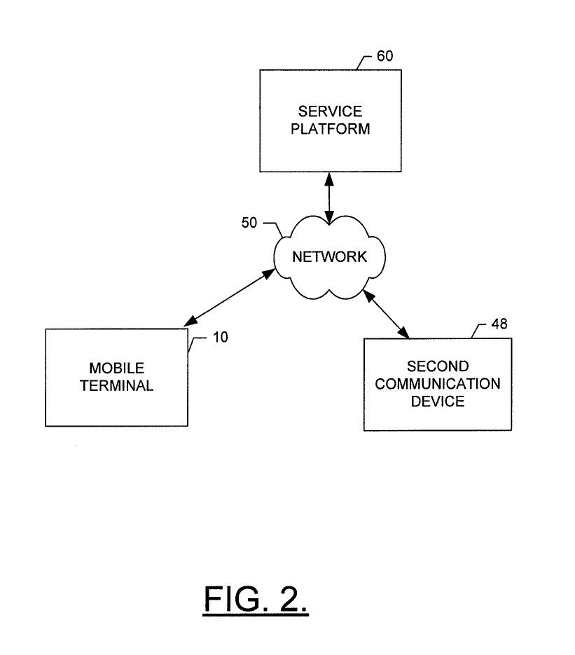

FIG. 2 is a schematic block diagram of a wireless communications system according to an example embodiment of the present invention. Referring now to FIG. 2, an illustration of one type of system that would benefit from embodiments of the present invention is provided. As shown in FIG. 2, a system in accordance with an example embodiment of the present invention includes a first communication device (e.g., mobile terminal 10) and in some cases also a second communication device 48 that may each be capable of communication with a network 50. The second communication device 48 may be another mobile terminal, or a fixed computer or computer terminal (e.g., a personal computer (PC)). The second communication device 48 is provided to illustrate that example embodiments may be practiced on multiple devices or in connection with multiple devices. Thus, there may be multiplicity with respect to instances of other devices that may be included in the network 50 and that may practice example embodiments independent of, or in connection with, the network 50. The communications devices of the system may be able to communicate with network devices or with each other via the network 50. In some cases, the network devices with which the communication devices of the system communicate may include a service platform 60. In an example embodiment, the mobile terminal 10 (and/or the second communication device 48) is enabled to communicate with the service platform 60 to provide, request and/or receive information. However, in some embodiments, not all systems that employ embodiments of the present invention may comprise all the devices illustrated and/or described herein.

In an example embodiment, the network 50 includes a collection of various different nodes, devices or functions that are capable of communication with each other via corresponding wired and/or wireless interfaces. As such, the illustration of FIG. 2 should be understood to be an example of a broad view of certain elements of the system and not an all inclusive or detailed view of the system or the network 50. Although not necessary, in some embodiments, the network 50 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), LTE advanced (LTE-A), and/or the like.

One or more communication terminals such as the mobile terminal 10 and the second communication device 48 may be capable of communication with each other via the network 50 and each may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other devices such as processing devices or elements (e.g., personal computers, server computers or the like) may be coupled to the mobile terminal 10 and the second communication device 48 via the network 50. By directly or indirectly connecting the mobile terminal 10, the second communication device 48 and other devices to the network 50, the mobile terminal 10 and the second communication device 48 may be enabled to communicate with the other devices (or each other), for example, according to numerous communication protocols including Hypertext Transfer Protocol (HTTP) and/or the like, to thereby carry out various communication or other functions of the mobile terminal 10 and the second communication device 48, respectively.

Furthermore, although not shown in FIG. 2, the mobile terminal 10 and the second communication device 48 may communicate in accordance with, for example, radio frequency (RF), Bluetooth (BT), Infrared (IR) or any of a number of different wireline or wireless communication techniques, including LAN, wireless LAN (WLAN), Worldwide Interoperability for Microwave Access (WiMAX), WiFi, ultra-wide band (UWB), Wibree techniques and/or the like. As such, the mobile terminal 10 and the second communication device 48 may be enabled to communicate with the network 50 and each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

In an example embodiment, the service platform 60 may be a device or node such as a server or other processing device. The service platform 60 may have any number of functions or associations with various services. As such, for example, the service platform 60 may be a platform such as a dedicated server (or server bank) associated with a particular information source or service (e.g., mapping services, content library (e.g., video, music, images, etc.), media rendering, and/or the like), or the service platform 60 may be a backend server associated with one or more other functions or services. As such, the service platform 60 represents a potential host for a plurality of different services or information sources. In some embodiments, the functionality of the service platform 60 is provided by hardware and/or software components configured to operate in accordance with known techniques for the provision of information to users of communication devices. However, at least some of the functionality provided by the service platform 60 is information provided in accordance with example embodiments of the present invention.

In an example embodiment, the service platform 60 may host an apparatus for providing services related to experiencing content that includes content tiles that are flippable based on a scrolling operation to a device practicing an embodiment of the present invention. As such, in some embodiments, the service platform 60 may itself perform example embodiments, while in other embodiments, the service platform 60 may facilitate (e.g., by the provision of content navigation services or processing of navigable content) operation of an example embodiment at another device (e.g., the mobile terminal 10 and/or the second communication device 48). In still other example embodiments, the service platform 60 may not be included at all. In other words, in some embodiments, operations in accordance with an example embodiment may be performed at the mobile terminal 10 and/or the second communication device 48 without any interaction with the network 50 and/or the service platform 60.

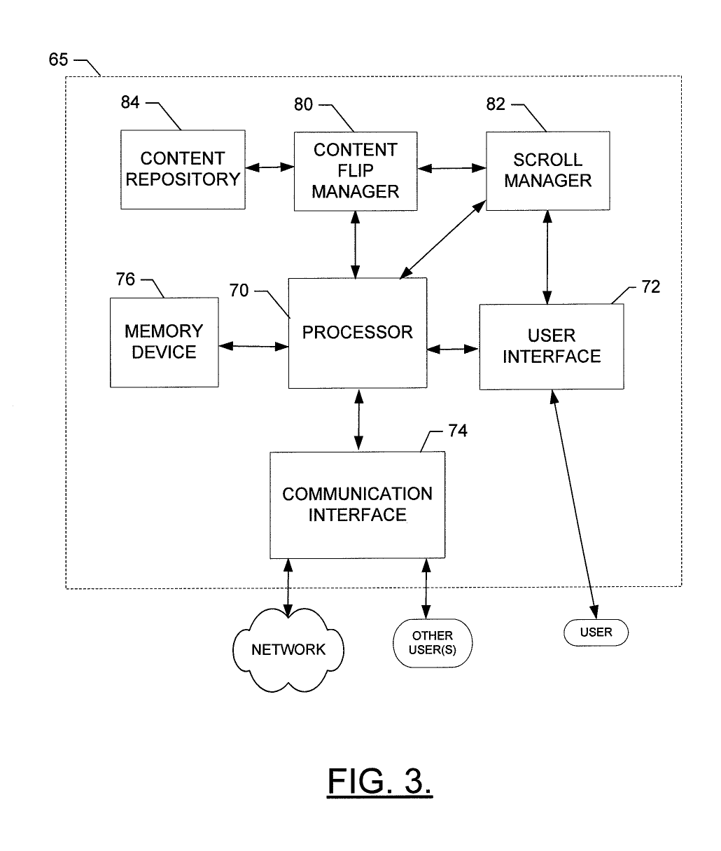

An example embodiment will now be described with reference to FIG. 3, in which certain elements of an apparatus for enabling the provision of content flipping based on a scrolling operation are displayed. The apparatus of FIG. 3 may be employed, for example, on the service platform 60, the mobile terminal 10 or second communication device 48 of FIG. 2. However, it should be noted that the apparatus of FIG. 3, may also be employed on a variety of other devices. Therefore, example embodiments should not be limited to application on devices such as the service platform 60, the mobile terminal 10 or second communication device 48 of FIG. 2. Alternatively, embodiments may be employed on a combination of devices including, for example, those listed above. Accordingly, some example embodiments may be embodied wholly at a single device (e.g., the service platform 60, the mobile terminal 10 or the second communication device 48) or by devices in a client/server relationship (e.g., the service platform 60 serving information to the mobile terminal 10 and/or the second communication device 48). Furthermore, it should be noted that the devices or elements described below may not be mandatory and thus some may be omitted in certain embodiments.

Referring now to FIG. 3, an apparatus 65 for enabling the provision of content flipping based on a scrolling operation is provided. The apparatus 65 may include or otherwise be in communication with a processor 70, a user interface 72, a communication interface 74 and a memory device 76. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device like the processor 70). The memory device 76 may be configured to store information, data, applications, instructions or the like for enabling the apparatus to carry out various functions in accordance with example embodiments of the present invention. For example, the memory device 76 could be configured to buffer input data for processing by the processor 70. Additionally or alternatively, the memory device 76 could be configured to store instructions for execution by the processor 70.

The apparatus 65 may, in some embodiments, be a network device (e.g., service platform 60) or other devices (e.g., the mobile terminal 10 or the second communication device 48) that may operate independent of or in connection with a network. However, in some embodiments, the apparatus 65 may be instantiated at one or more of the service platform 60, the mobile terminal 10 and the second communication device 48. Thus, the apparatus 65 may be any computing device configured to employ an example embodiment of the present invention. However, in some embodiments, the apparatus 65 may be embodied as a chip or chip set (which may in turn be employed at one of the devices mentioned above). In other words, the apparatus 65 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 65 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware or a combination of hardware and software that is configured to receive and/or transmit data from/to a network and/or any other device or module in communication with the apparatus 65. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen(s), touch areas, soft keys, a microphone, a speaker, or other input/output mechanisms. In an example embodiment in which the apparatus 65 is embodied as a server or some other network devices, the user interface 72 may be limited, or eliminated. However, in an embodiment in which the apparatus 65 is embodied as a communication device (e.g., the mobile terminal 10), the user interface 72 may include, among other devices or elements, any or all of a speaker, a microphone, a display, and a keyboard or the like. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an example embodiment, the processor 70 may be embodied as, include or otherwise control a content flip manager 80 and a scroll manager 82. As such, in some embodiments, the processor 70 may be said to cause, direct or control the execution or occurrence of the various functions attributed to the content flip manager 80 and the scroll manager 82, respectively, as described herein. The content flip manager 80 and the scroll manager 82 may each be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the content flip manager 80 and the scroll manager 82, respectively, as described herein. Thus, in examples in which software is employed, a device or circuitry (e.g., the processor 70 in one example) executing the software forms the structure associated with such means.

In some embodiments, the apparatus 65 may include or have access to a content repository 84. The content repository 84 may include content items associated with one or more content types and/or associated with one or more applications. The content repository 84 may also store information associated with the content items. For example, the stored information associated with a content item may include information such as a name or title of the content item, the date, time, and/or location of generation of the content item, a classification or description of the content item, a date, time and/or location of a last usage or rendering of the content item, an identification of a person, place or object associated with or in the content item, a source of the content item, a link to a website including more information about or associated with the content item, and/or the like. In some cases, the stored information may include information regarding links or relationships to other content items.

The scroll manager 82 may be configured to facilitate scrolling operations with respect to content displayed via the user interface 72. Thus, for example, the scroll manager 82 may generate a scroll cursor (e.g., for grabbing content to drag the content to initiate a scroll operation), one or more scroll bars (e.g., selection of which may be used to initiate directional scrolling based on the orientation of the selected scroll bar and perhaps also a magnitude of deflection of the selected scroll bar), scroll position indicators (e.g., to indicate a portion of content that is currently viewable relative to all available content, and/or other visual and/or selectable interface elements to facilitate scrolling. In some cases, a mouse wheel (or scroll wheel) may initiate scrolling via the scroll manager 82, which may scroll over content responsive to movement of the mouse wheel. Sliding, hovering or dragging motions on or relative to a touch screen display may also cause interaction with the scroll manager 82 to initiate scrolling over content being displayed.

The content flip manager 80 may be configured to cause the generation of content tiles that may include at least two sides associated with each content tile. In this regard, for example, the content flip manager 80 may provide information for display via the user interface 72 in association with an application being executed by the processor 70. The content tile may generally appear as a content item associated with the corresponding application, except that the content tile may be enabled to be flipped to reveal additional information or content based on a scrolling operation. Each content tile may include at least two possible display options. In an example embodiment, the content tiles may be visualized to appear to have two or more sides. Thus, for example, content tiles may be visualized to appear as a card that may be flipped, or as a multi-faceted wheel that may be flipped between different facets in one of two directions (e.g., up or down). However, in some cases, the content tiles could even be a multi-sided three dimensional object that may be flipped in more than two directions (e.g., up, down, right and left). Similarly, if scrolling is enabled to move in free directions, a scroll in a 35 degree direction may cause content tile flipping at the same angle (e.g., 35 degrees). Generally speaking, the content flip manager 80 may be configured to flip content tiles from one face or side to another face or side based on a scroll operation.

As such, in some embodiments, the content flip manager 80 may be configured to interact with the content repository 84 in order to associate content items and/or information associated with the content items from the content repository 84 with respective sides of a content tile. The content flip manager 80 may also be configured to interact with the scroll manager 82 in order to determine or monitor scrolling operations in order to determine whether to initiate a flip for one or more content tiles. In an example embodiment, the content flip manager 80 may be configured to establish a flip trigger for one or more content tiles based on a position of the content each content tile relative to a display view shown via the user interface 72. Thus, for example, a midpoint (or any other point) of the display view may be defined as a trigger location such that when a portion of the content tile reaches the trigger location, a flip of the content tile from a first side to a second side may be initiated. In some embodiments, the speed of scrolling may also impact content flipping. For example, scroll speed may impact what is seen on the other side after a flip operation, which tiles are flipped and which are not, and whether tiles are flipped at all (e.g., some tiles may only flip responsive to a scroll speed greater than a given threshold).

In some cases, the trigger location may be directionally sensitive. Thus, for example, an approach to the trigger location from a first location (e.g., below the midpoint) toward a second location (e.g., a top of the display view) may cause a flipping of the content tile in a corresponding direction when the trigger location is reached. However, approaching the trigger location from the second location moving toward the first location may cause a flipping of the content tile in an opposite direction when the trigger location is reached. In some cases, the direction of triggering may not matter and the content tile may flip in the same direction each time the trigger location is reached. In an example embodiment, the flip of a content tile may occur instantaneously responsive to reaching the trigger location. However, in alternative embodiments, the flip may occur gradually as the scroll operation takes the content tile past the trigger location.

In some embodiments, the content tile may include at least a first side (or one potentially presentable view) that includes a content item or information associated with a content item. A second side of the content tile may include another content item that may be related or unrelated to the content item on the first side. Moreover, in some cases, that which is shown on the second side may depend on the scrolling operation, current user location, time, or other factors. These factors may also impact whether or not certain tiles flip under corresponding certain situations. Alternatively, the second side may include information corresponding to the content item on the first side. The content tiles may be used in many different environments. For example, in some cases, the content tiles may be provided either alone or with a plurality of other content tiles such that all content items presented in a particular display view are content items associated with a particular side of a content tile. However, in other examples, one or more content tiles may be mixed into an environment in which both content items that do not flip and content tiles are presented together. The content tiles may be presented to be visually indistinguishable from other content items, or the content tiles may be distinguished from other content items with some form of visual indicator (e.g., a symbol, a form of highlighting, a marking, and/or the like) to indicate the presence or nature of the content tile. In still other examples, the content tiles may be portions of an otherwise consistent display view of a particular content item associated with an application. For example, in some cases, a content tile may form a portion of a map display provided by a mapping application or service. In another example, a content tile may form a portion of a larger image (e.g., with the content tile being associated with a particular person or object displayed in an image). In such examples, the content item displayed on the first side of the content tile may be a portion of an image that matches the corresponding portion of the image that is covered up by or replaced by the content tile. As such, in some cases, the content tile (which is a portion of a larger display) may be visually indistinguishable from other portions of the displayed content (e.g., map or image) until a content flip occurs. However, in other cases, the content tile may have some form of border, highlighting or other visual indicator to show that the corresponding portion is a content tile. In such an example, the visual indicator may be continuously present or may become visible when the user is scrolling and is approaching the trigger location for a particular content item. In an example embodiment, an alternative side of a tile may include video, music or a different type of content that may automatically begin playing responsive to a content tile flip, or may start responsive to user input after a content flip. In some cases, volume of played content may be determined by the speed, angle or other characteristics of the flip operation.

As indicated above, the content tiles may be associated with various different applications or content types. Moreover, the content tiles may be presented (alone or with other content tiles or content items) in any of a number of formats. For example, content items and/or tiles may be presented in a gallery format (e.g., with a plurality of content items being displayed over a display view rendered on a visual display). As another example, content items and/or content tiles may be presented in a list format (e.g., as a list of files names or content item identifiers). As yet another example, content items and/or content tiles may be presented in an unformatted manner (e.g., as a portion of a map or an image). Some examples will now be described, but it should be appreciated that these examples are not limiting, but merely provided to illustrate how some example embodiments may be employed.

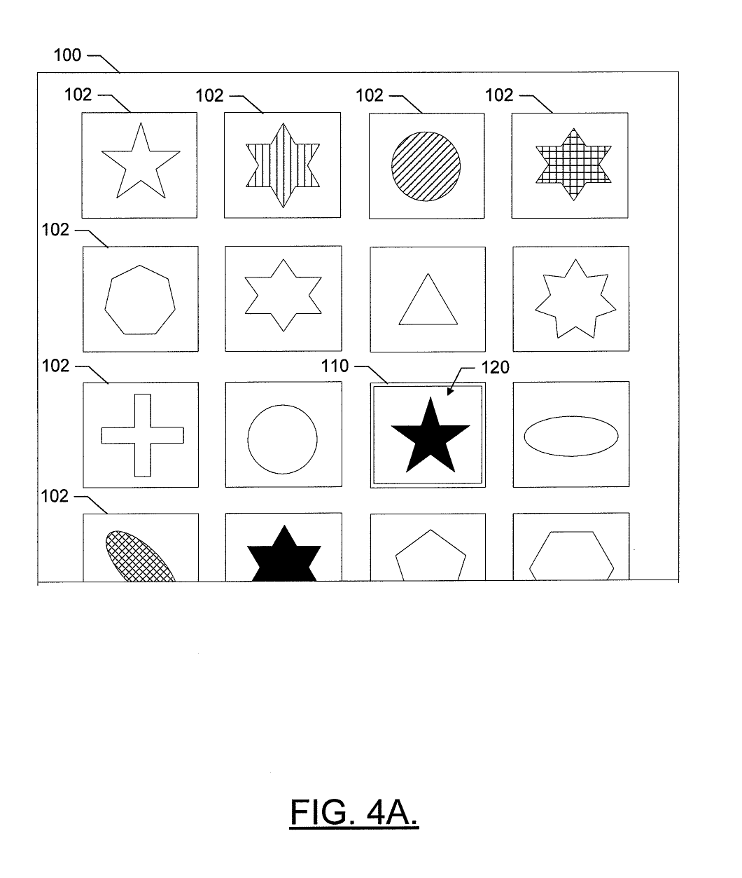

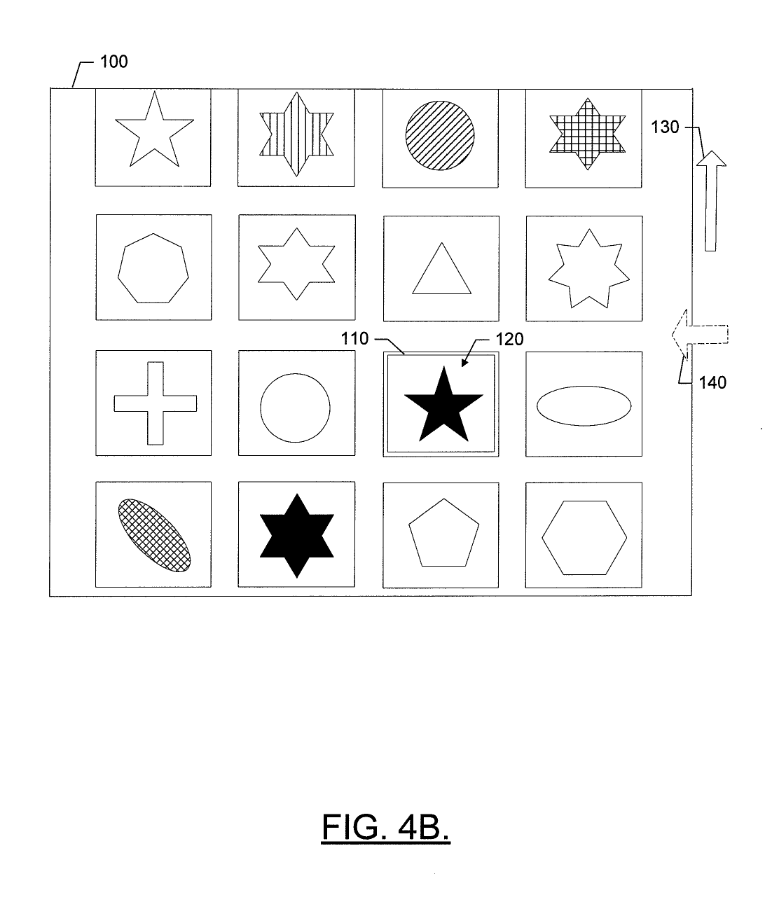

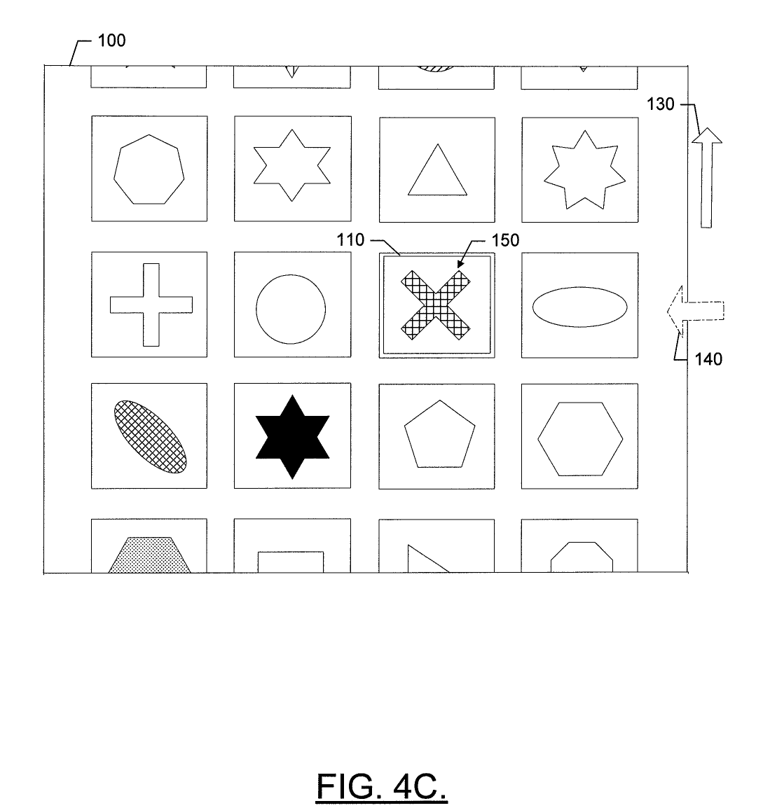

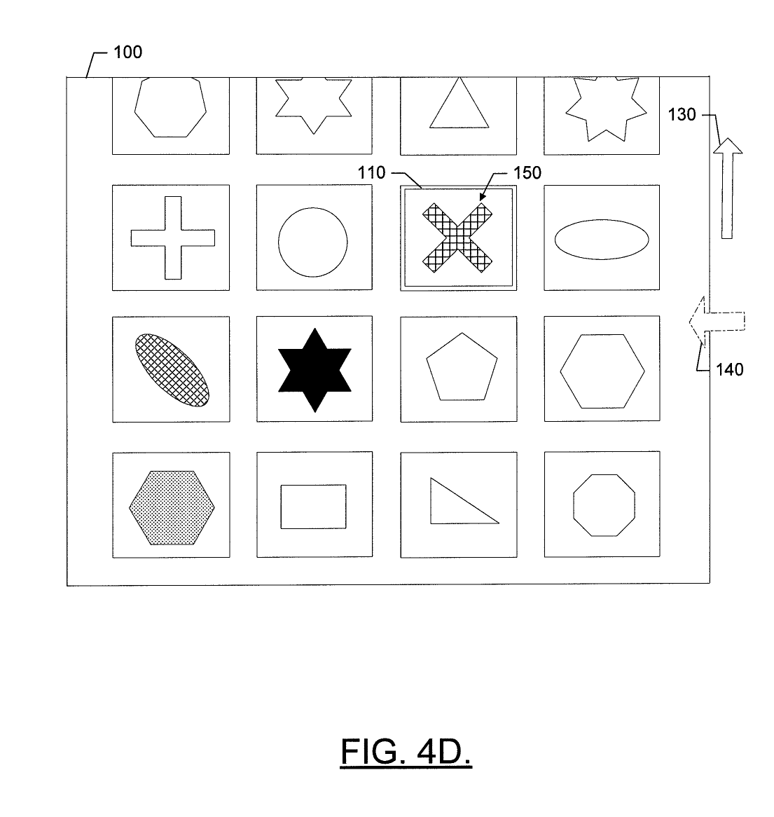

FIG. 4, which includes FIGS. 4A, 4B, 4C and 4D illustrates an example of content items (in this case images of shapes) displayed in a gallery format on a display view 100 generated by an electronic device (e.g., the mobile terminal 10 or the second communication device 48). It should be appreciated that the content items could be images of people or places in other examples, and the images of shapes are presented here for ease of explanation and rendering. FIG. 4A shows a plurality of content items 102 and a content tile 110. A first side 120 of the content tile 110 is being displayed initially. In this case the content tile 110 is highlighted to draw attention to it as a content tile. However, in other examples, no such highlighting may be employed and the content tile 110 may appear to be visually indistinguishable from the other content items 102 as being a content tile.

FIG. 4B shows movement of the gallery of images responsive to scrolling (as represented by arrow 130). The scrolling may be provided on a touch screen or on a display that is not responsive to touch inputs. Some examples could also be performed in connection with hovering sensitive screens that require only that a finger or other object be above the screen within a particular distance. Furthermore, although arrow 130 shows vertical scrolling, horizontal scrolling or other directional scrolling (e.g., diagonal, three dimensional, etc.) may also be performed in other examples. Moreover, the scrolling may be provided, through manipulation of a scroll bar, mouse wheel, click and drag or any other scrolling method. In this example, assume the trigger location 140 to be approximately located at a middle of the display view 100 and thus the first side of the content tile 110 is still displayed. In FIG. 4C, the content tile 110 has reached the trigger location 140 and the content tile 110 is flipped (e.g., by the content flip manager 80) to a second side 150, which displays different content than that which was displayed on the first side 120. As the content moves on to the point shown in FIG. 4D due to continued scrolling (still shown by arrow 130), the content tile 110 continues to display the second side 150 and the corresponding content. However, if the scrolling direction was changed and the content tile 110 moved back to the trigger location 140, the content tile 110 may shift back to displaying the first side 120 (or another side if more than two sides are used).

In this example, both the first side 120 and second side 150 include images. The images may be related or unrelated. For example, in some cases first and second sides of a content tile may each have images of the same person, of the same place, of the same object, or taken at the same time or event. However, in other cases, there may be no relationship between content items on respective first and second sides. In an alternative example, the second side may include information about the image displayed on the first side. For example, the second side may indicate an identity of the person, place or object pictured on the first side. Alternatively, the second side may indicate metadata descriptive of context information associated with the image on the first side. In still other alternatives, the second side may have links to further information about the image on the first side.

In an example in which the images in the display view are associated with contacts (e.g., presenting thumbnail images of friends or contacts in an address book in a gallery format), the second side may include contact information associated with the person pictured on the first side. Moreover, the second side may include selectable links to mechanisms to employ the contact information to contact the corresponding contact pictured on the first side (e.g., a menu of options enabling calling, texting, emailing, etc., the corresponding contact).

In an example in which images in the display view are associated with content items of a specific type, the first side of the content tile may show some form of identifying indicia that corresponds to content of the specific type (e.g., book covers, album covers, movie covers, and/or the like). The second side of the content tile may show information on where the corresponding content may be purchased or sampled (or links to such websites), or links to corresponding chapters from a book, songs from an album or artist, or scenes from a movie. Other information (e.g., release date, production company, other titles from the same artist, and/or the like) may also or alternatively be provided.

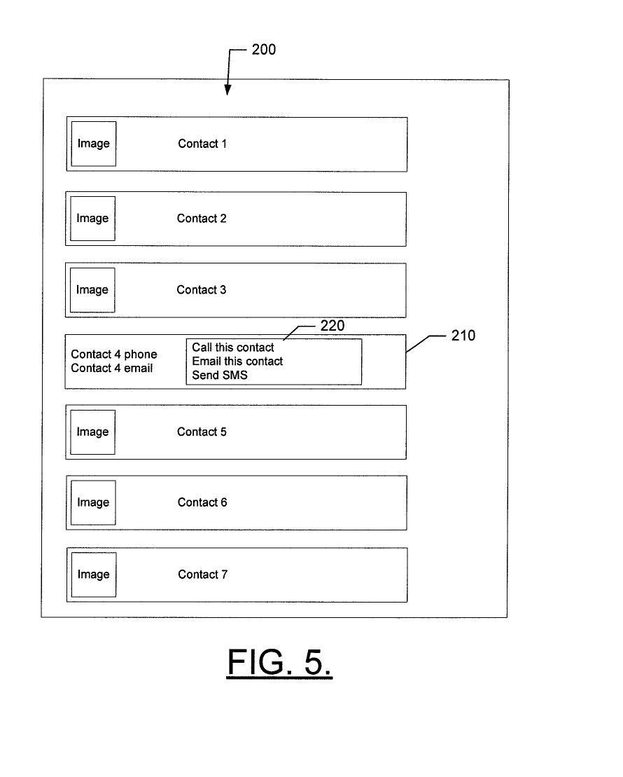

As indicated above, example embodiments may not only be applicable in relation to content items presented in a gallery type format. FIG. 5 illustrates an example embodiment presented in a list format. In the example of FIG. 5, a series of contacts 200 are presented in a list format. The contacts may each include illustrations of first-side content for each of a plurality of content tiles corresponding to the contacts. As a contact associated with a content tile reaches the trigger location, the contact may be flipped to illustrate second-side content 210. The second side content 210 may include menu of connection options 220 (as shown in FIG. 5), or contact status (e.g., currently online, offline, last login, last comment posting, etc.), or other information associated with the corresponding contact. Numerous other types of content items could also be employed in connection with content tiles according to other example embodiments.

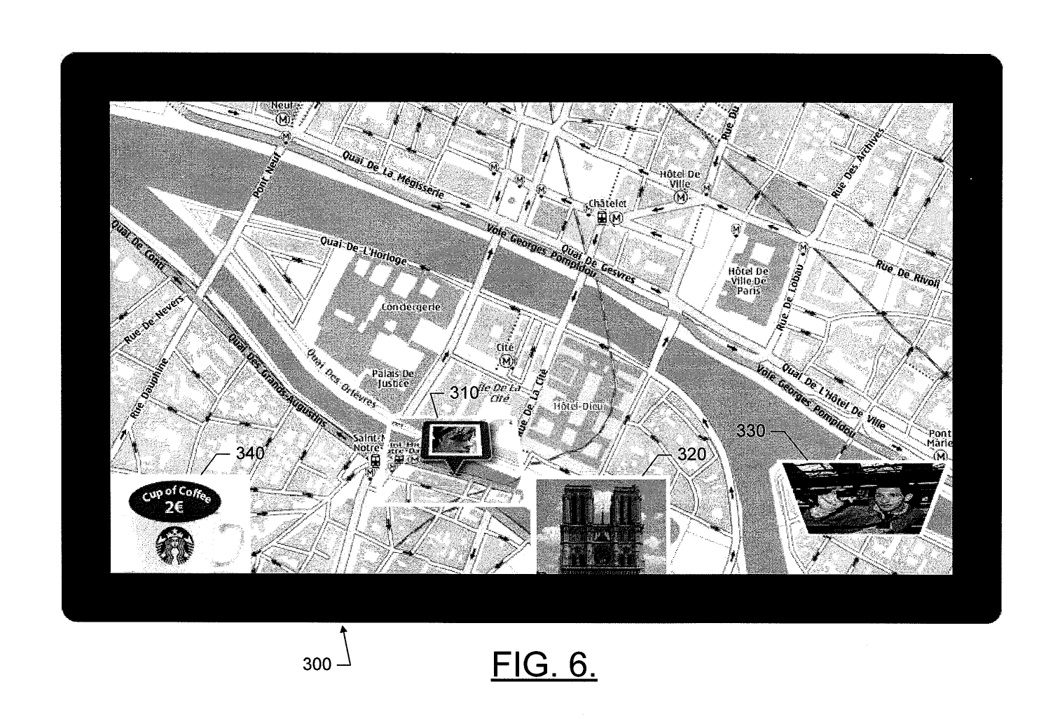

FIG. 6 illustrates another example embodiment employing content tiles in a different format. In this regard, FIG. 6 illustrates the use of content tiles in connection with a map service or application. A map view 300 is shown with various content tiles 310, 320, 330 and 340 disposed thereon. The content tiles may each include map data on a first side, where the map data corresponds to the respective portion of the map over which the content tile is positioned. On the second side, any number of other content items may be presented when the content tile is flipped responsive to scrolling. For example, images associated with an area may be displayed in association with the corresponding area (e.g., content tile 330) on the second side of a corresponding content tile. Contacts (or images of contacts such as is shown in content tile 310) at a particular location may form the second side of other content tiles. Images or information regarding points of interest (e.g., content tile 320) may also be displayed as second side-content when a corresponding content tile is flipped. In this case, an image is displayed for the point of interest (Notre Dame Cathedral). However, hours of operation, contact information, pricing guides and other data may also be provided. Furthermore, in some cases, coupons or other incentives may be provided in connection with a particular location corresponding to a content tile (e.g., content tile 340). Other content tiles may include information relating to messages associated with a location, public transportation routes, schedules, prices, and/or the like.

Accordingly, example embodiments may provide robust opportunities for designers to generate content tiles to provide users with access to different functions and/or content items. Users may enjoy accessing content in an intuitive or interesting way by scrolling over a content view until specific content tiles within the view reach a designated location (e.g., the trigger location) to trigger flipping of content tiles from at least a first side view to a second side view.

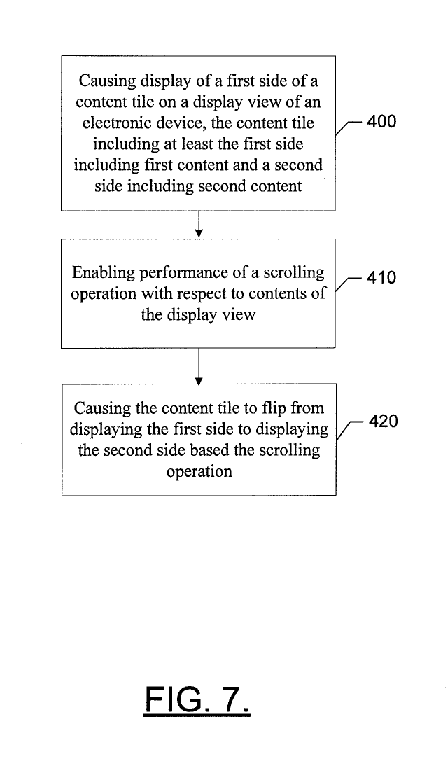

FIG. 7 is a flowchart of a system, method and program product according to example embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus embody a mechanism for implementing the functions specified in the flowchart block(s). These computer program instructions may also be stored in a computer-readable storage memory (as opposed to a transmission medium such as a carrier wave or electromagnetic signal) that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s). As such, the operations of FIG. 7, when executed, convert a computer or processing circuitry into a particular machine configured to perform an example embodiment of the present invention. Accordingly, the operations of FIG. 7 define an algorithm for configuring a computer or processing circuitry (e.g., processor 70) to perform an example embodiment. In some cases, a general purpose computer may be provided with an instance of the content flip manager 80, which performs the algorithm shown in FIG. 7 (e.g., via configuration of the processor 70), to transform the general purpose computer into a particular machine configured to perform an example embodiment.

Accordingly, blocks of the flowchart support combinations of means for performing the specified functions, combinations of operations for performing the specified functions and program instructions for performing the specified functions. It will also be understood that one or more blocks of the flowchart, and combinations of blocks in the flowchart, can be implemented by special purpose hardware-based computer systems which perform the specified functions or operations, or combinations of special purpose hardware and computer instructions.

In this regard, one embodiment of a method according to an example embodiment as shown in FIG. 7 may include causing display of a first side of a content tile on a display view of an electronic device where the content tile includes at least the first side including first content and a second side including second content at operation 400, enabling performance of a scrolling operation with respect to contents of the display view at operation 410, and causing the content tile to flip from displaying the first side to displaying the second side based on the scrolling operation at operation 420.

In some embodiments, certain ones of the operations above may be modified or further amplified as described below. Moreover, in some embodiments additional optional operations may also be included. It should be appreciated that each of the modifications, optional additions or amplifications below may be included with the operations above either alone or in combination with any others among the features described herein. In an example embodiment, causing the content tile to flip may include causing the content tile to flip from displaying the first side to displaying the second side responsive to a position of the content tile being scrolled at least to a trigger location defined with respect to the display view. In some embodiments, causing the content tile to flip may include causing the content tile to flip between sides of the content tile based on a direction of movement of the scrolling operation with respect to a trigger location defined with respect to the display view. In an example embodiment, first content may include a map view corresponding to a portion of a map and the second content may include information associated with a location corresponding to the portion of the map. In some cases, the first content may include an image of a content item and the second content may include information associated the content item. In some examples, the first content may include an image of a content item and the second content may include an image of another content item that is related or unrelated to the content item. In an example embodiment, the first content may include a contact and the second content may include selectable options for contacting the contact.

In an example embodiment, an apparatus for performing the method of FIG. 7 above may comprise a processor (e.g., the processor 70) configured to perform some or each of the operations (400-420) described above. The processor 70 may, for example, be configured to perform the operations (400-420) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 400-420 may comprise, for example, the content flip manager 80. Additionally or alternatively, at least by virtue of the fact that the processor 70 may be configured to control or even be embodied as the content flip manager 80, the processor 70 and/or a device or circuitry for executing instructions or executing an algorithm for processing information as described above may also form example means for performing operations 400-420.

An example of an apparatus according to an example embodiment may include at least one processor and at least one memory including computer program code. The at least one memory and the computer program code may be configured to, with the at least one processor, cause the apparatus to perform the operations 400-420 (with or without the modifications and amplifications described above in any combination).

An example of a computer program product according to an example embodiment may include at least one computer-readable storage medium having computer-executable program code portions stored therein. The computer-executable program code portions may include program code instructions for performing operation 400-420 (with or without the modifications and amplifications described above in any combination).

In some cases, the operations (400-420) described above, along with any of the modifications may be implemented in a method that involves facilitating access to at least one interface to allow access to at least one service via at least one network. In such cases, the at least one service may be said to perform at least operations 400-420.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
causing display of a first side of a content tile on a display view of an electronic device, the content tile including at least the first side including first content and a second side including second content;
enabling performance of a scrolling operation with respect to contents of the display view; and
causing the content tile to flip from displaying the first side to displaying the second side based on the scrolling operation.

2. The method of claim 1, wherein causing the content tile to flip comprises causing the content tile to flip from displaying the first side to displaying the second side responsive to a position of the content tile being scrolled at least to a trigger location defined with respect to the display view.

3. The method of claim 1, wherein causing the content tile to flip comprises causing the content tile to flip between sides of the content tile based on a direction of movement of the scrolling operation with respect to a trigger location defined with respect to the display view.

4. The method of claim 1, wherein the first content comprises a map view corresponding to a portion of a map and the second content comprises information associated with a location corresponding to the portion of the map.

5. The method of claim 1, wherein the first content comprises an image of a content item and the second content comprises information associated the content item.

6. The method of claim 1, wherein the first content comprises an image of a content item and the second content comprises an image of another content item that is related or unrelated to the content item.

7. The method of claim 1, wherein the first content comprises a contact and the second content comprises selectable options for contacting the contact.

8. An apparatus comprising at least one processor and at least one memory including computer program code, the at least one memory and the computer program code configured to, with the at least one processor, cause the apparatus to at least:
cause display of a first side of a content tile on a display view of an electronic device, the content tile including at least the first side including first content and a second side including second content;
enable performance of a scrolling operation with respect to contents of the display view; and
cause the content tile to flip from displaying the first side to displaying the second side based on the scrolling operation.

9. The apparatus of claim 8, wherein the at least one memory and computer program code are configured to, with the at least one processor, cause the apparatus to cause the content tile to flip by causing the content tile to flip from displaying the first side to displaying the second side responsive to a position of the content tile being scrolled at least to a trigger location defined with respect to the display view.

10. The apparatus of claim 8, wherein the at least one memory and computer program code are configured to, with the at least one processor, cause the apparatus to cause the content tile to flip by causing the content tile to flip between sides of the content tile based on a direction of movement of the scrolling operation with respect to a trigger location defined with respect to the display view.

11. The apparatus of claim 8, wherein the first content comprises a map view corresponding to a portion of a map and the second content comprises information associated with a location corresponding to the portion of the map.

12. The apparatus of claim 8, wherein the first content comprises an image of a content item and the second content comprises information associated the content item.

13. The apparatus of claim 8, wherein the first content comprises an image of a content item and the second content comprises an image of another content item that is related or unrelated to the content item.

14. The apparatus of claim 8, wherein the first content comprises a contact and the second content comprises selectable options for contacting the contact.

15. A computer program product comprising a computer-readable medium bearing computer program code embodied therein for use with a computer, the computer program code comprising code for:
causing display of a first side of a content tile on a display view of an electronic device, the content tile including at least the first side including first content and a second side including second content;
enabling performance of a scrolling operation with respect to contents of the display view; and
causing the content tile to flip from displaying the first side to displaying the second side based on the scrolling operation.

16. The computer program product of claim 15, wherein code for causing the content tile to flip comprises code for causing the content tile to flip from displaying the first side to displaying the second side responsive to a position of the content tile being scrolled at least to a trigger location defined with respect to the display view.

17. The computer program product of claim 15, wherein code for causing the content tile to flip comprises code for causing the content tile to flip between sides of the content tile based on a direction of movement of the scrolling operation with respect to a trigger location defined with respect to the display view.

18. The computer program product of claim 15, wherein the first content comprises a map view corresponding to a portion of a map and the second content comprises information associated with a location corresponding to the portion of the map.

19. The computer program product of claim 15, wherein the first content comprises an image of a content item and the second content comprises information associated the content item or an image of another content item that is related or unrelated to the content item.

20. The computer program product of claim 15, wherein the first content comprises a contact and the second content comprises selectable options for contacting the contact.
